(19) United States
(12) Patent Application Publication
(10) Pub. No.: US 2005/0207706 A1
(43) Pub. Date: Sep. 22, 2005

(54) Method of radiusing and beam profiling optical fiber tips mounted in a polishing fixture and apparatus used therefor

(76) Inventors: Terrance J. Schmidt, Ocean, NJ (US); Alfred J. Cheswick, Loch Arbour, NJ (US); Cuneyt Erdogan, Franklin Park, NJ (US)

Correspondence Address: Alfred J. Cheswick, 104 Ocean Avenue, Loch Arbour, NJ, 07711, US

(21) Appl. No.: 10/805,439

(22) Filed: Mar. 19, 2004

(51) Int. Cl. G02B 6/38

(52) U.S. Cl. 385/55; 385/39; 385/50; 385/51; 385/54; 385/40; 385/43

(57) ABSTRACT

An apparatus that enables the radiusing and beam profiling of an optical fiber tip protruding from a polishing fixture. When engaged with the polishing fixture, the apparatus positions the fiber tip in a high temperature plasma field generate by an electrode pair. The apparatus is provided with a window that permits the active viewing and monitoring of radiusing procedure. After the radiusing procedure, the same apparatus also permits the analysis of the beam pattern created when light is transmitted through the radiused fiber tip.

### FIELD OF THE INVENTION

The present invention generally relates to a method and to devices enabling an optical fiber tip to be radiused with subsequent beam profiling, and more particularly to an apparatus that permits these two operations to be performed with a single integrated device that can be engaged with a polishing fixture.

### BACKGROUND OF THE INVENTION

Light energy emitted by opto-electrical devices such as lasers and light emitting diodes (LEDs) are often coupled into optical fibers. The optical output and input of other devices such as array wavelength gratings (AWGs), planar waveguides and wave division multiplexers (WDM) are also coupled with fibers. Accurate, sub-micron alignment is required to achieve maximum coupling efficiency.

The emitted beam pattern of many optical devices is not circular. However the numerical aperture and acceptance angle of optical fibers are typically uniform, optimized to receive a circular beam. Therefore, discreet micro lens systems must be designed into opto-electronic packages to convert the beam pattern and assist with focusing into the fiber. These lens systems are difficult to align, add cost and increase packaging size.

As an option to lens systems, the tip of a receiving or transmitting fiber can be shaped to create an integrated lens. Holding the bare fiber tip in a polishing fixture at a specific angle, and polishing it into shapes such as cones, chisels, wedges and combinations thereof accomplish this. Once shaped, the pointed fiber tip is then radiused to create a lens. This radiusing procedure is usually accomplished by introducing the fiber tip to a plasma field created by the arcing of a high voltage power source. The heat generated in the plasma field melts the fiber tip forming the lensing radius. Subsequent to creating the lensed tip, the fiber is then tested to analysis its beam pattern. Light is injected into the fiber, and its output pattern is then detected by a charge coupled device (CCD) camera. The video signal from the CCD is analyzed by beam profiling software that computes information such as the aspect ratio of the pattern, numerical aperture and mode field diameter (MFD) of the fiber. If this data corresponds with the output of the opto-electronic device, maximum coupling efficiency can be insured.

Prior art has demonstrated that machines have been developed to polish bare fibers into shapes such as cones, chisels and wedges. Standard telecommunication fusion splicers are often used to radius fiber tips with their arcing action. CCD cameras, video capture boards and beam profiling software are commercially available for the analysis of lensed fiber light output. While each of these processing systems is capable of performing their own specific task, they are separate and independent equipment.

The requirement to carry a fiber to and fro between processing equipment is a significant shortcoming in prior art. Fixturing, mounting and alignment of the fiber in each piece of processing equipment are time-consuming, labor intensive and cumbersome. The also exists a high probability of damage to the fragile fiber tip during transfer. Additionally, the fiber is susceptible to potential contamination by dust and debris.

Prior art also has a significant shortcoming regarding final fiber qualification and rework. An unacceptable fiber is not determined until it has been transfer to the beam analysis step. At this point it must be returned to one of the previous polishing or fusion steps for corrective action. This rework process subjects the fiber to the shortcomings outlined in the preceding paragraph.

An additional significant shortcoming of prior art is the cumbersome procedures required during the development of fiber radiusing processes. In order to monitor the effects of varying intensities and durations of plasma fields upon the shaped fiber tip, the fiber must constantly be moved back and forth between the fusion splicing station and the beam profiling system. Once again the shortcomings outlined in the previous paragraphs are encountered.

### SUMMARY OF THE INVENTION

Therefore, it is the objective of the invention to provide a means for radiusing a shaped fiber tip and analyzing its beam profile with a single probe device, while the fiber is loaded in its polishing fixture.

An advantage of the present invention is to provide a single probe device that integrates a CCD camera with a fusion module. The fusion module is provided with two electrodes that are capable of being energized to create a plasma field.

Still another advantage of the present invention is that it is fabricated into a probe that can interface with the polishing fixture of a fiber-shaping machine. This engagement positions the shaped fiber between the electrodes, and above the active surface of the CCD camera.

A further advantage of the present invention is that it is formed with a viewing window through which the positioning of the shaped fiber in reference to the electrodes can be confirmed. Additionally, the effects of each iterative arc of plasma upon the shaped fiber tip can be monitored without removing the invention from the polishing fixture. The formed radius can therefore be measured with the invention positioned upon the polishing fixture.

An additional advantage of the present invention is that it incorporates a shutter device that can cover the viewing window in order to prevent ambient light from striking the CCD during beam profiling.

It is still another advantage of the present invention that the beam profile of the newly radiused fiber tip can be analyzed immediately after plasma arcing while the invention is still engaged with the polishing fixture.

If it is determined that additional radiusing is required, the present invention provides the advantage of immediately inducing additional plasma arcing without removing the invention from the polishing fixture.

Another advantage of the present invention is if beam profiling determines that the fiber has not been properly shaped, the invention can be removed from the polishing fixture, and the fiber is immediately ready to be re-polished without the need to re-fixture the fiber in the polishing mechanism.

Other advantages of the invention will become apparent upon reading the following detailed description and upon reference to the accompanying drawings.

### BRIEF DESCRIPTION OF THE DRAWINGS

For a more complete understanding of this invention, reference should now be had to the embodiments illustrated in greater detail in the accompanying drawings and described below by way of examples of the invention.

FIG. 1 is an isometric view of the fusion module from the bottom surface.

FIG. 2 is an isometric view of the fusion module from the top surface.

FIG. 3 is an isometric, exploded view of the invention illustrating the fusion module and the CCD camera.

FIG. 4 is a side view of a polishing fixture with a fiber inserted.

FIG. 5 is the polishing fixture of FIG. 4 rotated 90 degrees.

FIG. 6 is a cross sectional view of the invention with a polishing fixture and fiber inserted.

FIG 7 is a cross sectional view of the invention with a polishing fixture and fiber inserted, rotated 90 degrees. Also illustrated is a microscope positioned to focus inside the viewing window.

FIG. 8 is a detailed view of a shaped fiber, located between two electrodes, being illuminated by a light source and emitting light upon a CCD camera's active area.

FIG. 9 illustrates the light pattern profile projected upon the CCD active area resulting from the configuration of FIG. 8.

FIG. 10 illustrates the plasma field generated between the two electrodes.

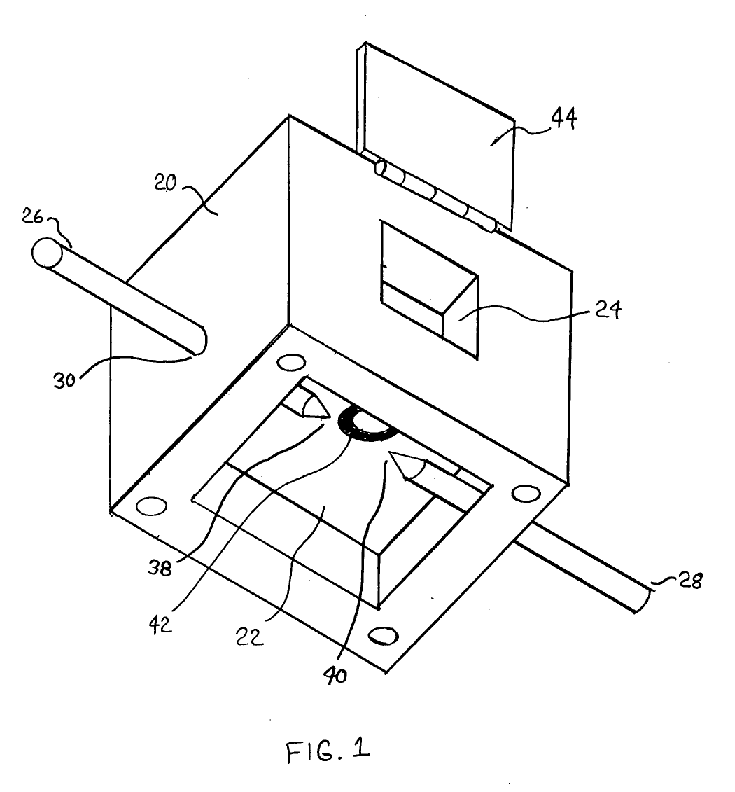

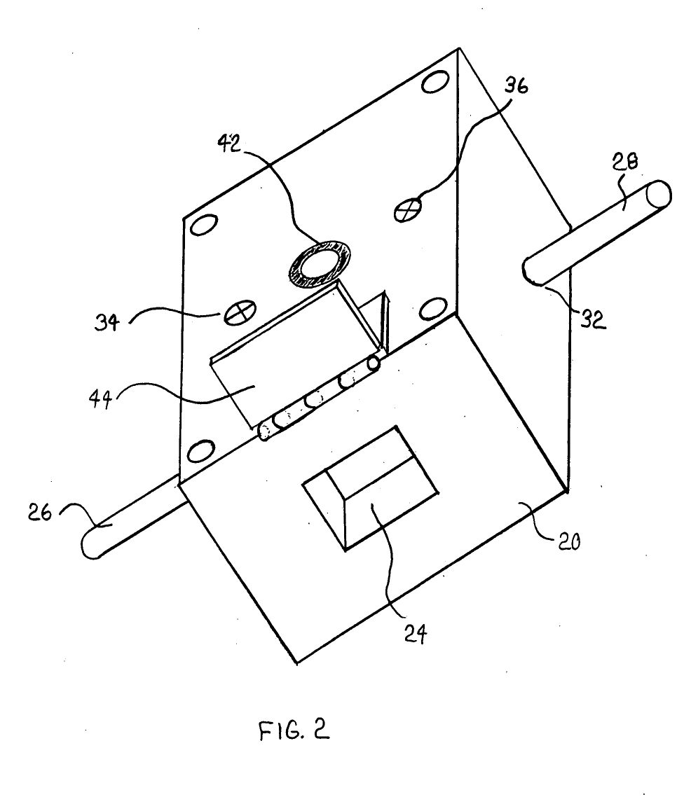

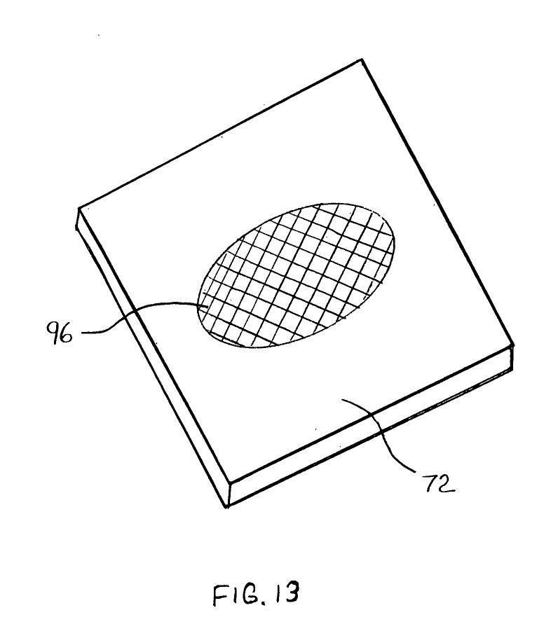

FIG. 1I illustrates the radiusing effect of the plasma field of FIG. 10.

FIG. 12 is a detailed view of a shaped and radiused fiber, located between two electrodes, being illuminated by a light source and emitting light upon a CCD camera active area.

FIG. 13 illustrates the light pattern profile projected upon the CCD active area resulting from the configuration of FIG. 12

While the invention will be described in connection with a preferred embodiment, it will be understood that it is not intended to limit the invention to that embodiment. On the contrary, it is intended to cover all alternatives, modifications and equivalents as may be included within the spirit and scope of the following description.

### DETAILED DESCRIPTION OF THE PREFERRED EMBODIMENT

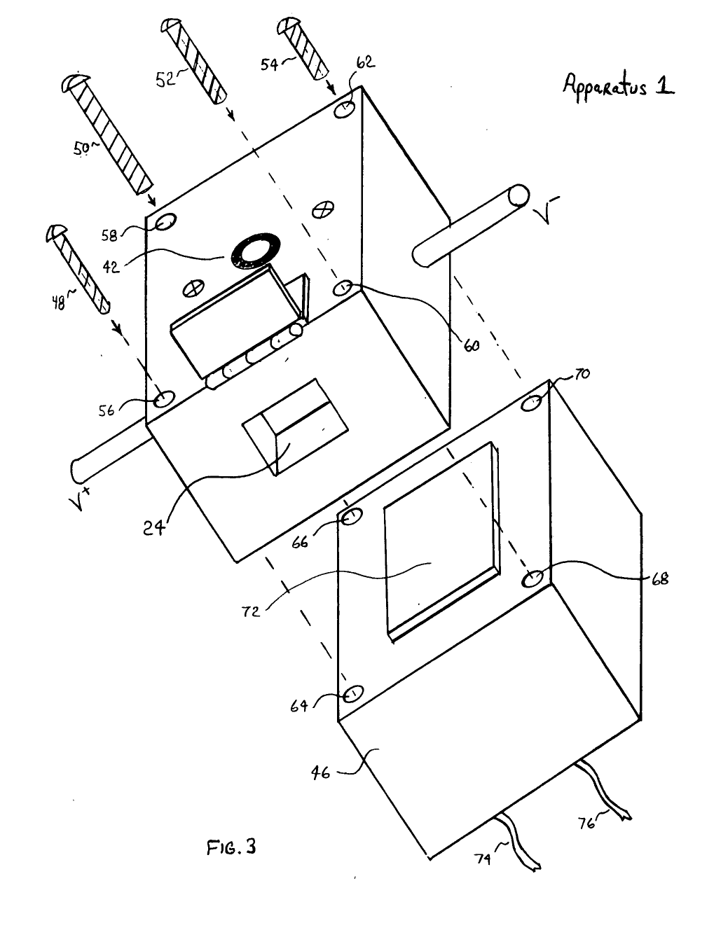

Referring to FIG. 1 and FIG. 2, apparatus 1 is provided with a fusion module 20. A cavity 22 has been formed, opening from the bottom surface of fusion module 20. The front surface of fusion module 20 is provided with a viewing window 24 that opens into cavity 22. Suitable materials for fusion module 20 are non-conductive dielectrics such Delrin® and Torlon®. Delrin is preferred.

Electrodes 26 and 28 are mounted and axially aligned by through holes 30 and 32. Electrodes 26 and 28 are positioned within cavity 22 and secured by set screws 34 and 36, respectively. Electrodes 26 and 28 are formed with tips 38 and 40, respectively. The axial gapping of tips 38 and 40 are controlled by set screws 34 and 36, respectively. Suitable materials for electrodes 26 and 28 are conductive substances. Tungsten is preferred.

A bushing 42 is mounted through the top surface of fusion module 20. The center of bushing 42 opens into cavity 22. The centerline of bushing 42 is positioned in the same plane created by the axis of electrodes 26 and 28. Suitable materials for bushing 42 are steel, zirconia, alumina and ceramics. The inside diameter of bushing 42 is large enough to accept the insertion of an industry standard optical ferrule and commercially available bare fiber polishing fixture.

A shutter means 44 is secured to the top surface of fusion module 20. Suitable shutter means 44 include conventional piano hinges. Shutter means 44 can be secured to fusion module 20 by either set screws or adhesives. Shutter means 44 has sufficient surface area, and is positioned upon fusion module 20, such that when closed, shutter means 44 covers and optically seals viewing window 24.

Referring next to FIG. 3, fusion module 20 is provided with through holes 56, 58, 60 and 62. A charge coupled device (CCD) camera 46 is provided with threaded holes 64, 66, 68 and 70. Fusion module 20 is preferably attached to camera 46 by inserting mounting screws 48, 50, 52 and 54 into through holes 56, 58, 60 and 62 and engaging with threaded holes 64, 66, 68 and 70.

Camera 46 is provided with a CCD active area 72. Upon attachment of fusion module 20 with camera 46, the center of active area 72 is aligned with the centerline of bushing 42. Camera 46 has an output video signal lead 74 and power lead 76. Output video signal lead 74 interfaces with a PC video capture board (not shown). Power lead 76 is energized by conventional power supplies (not shown).

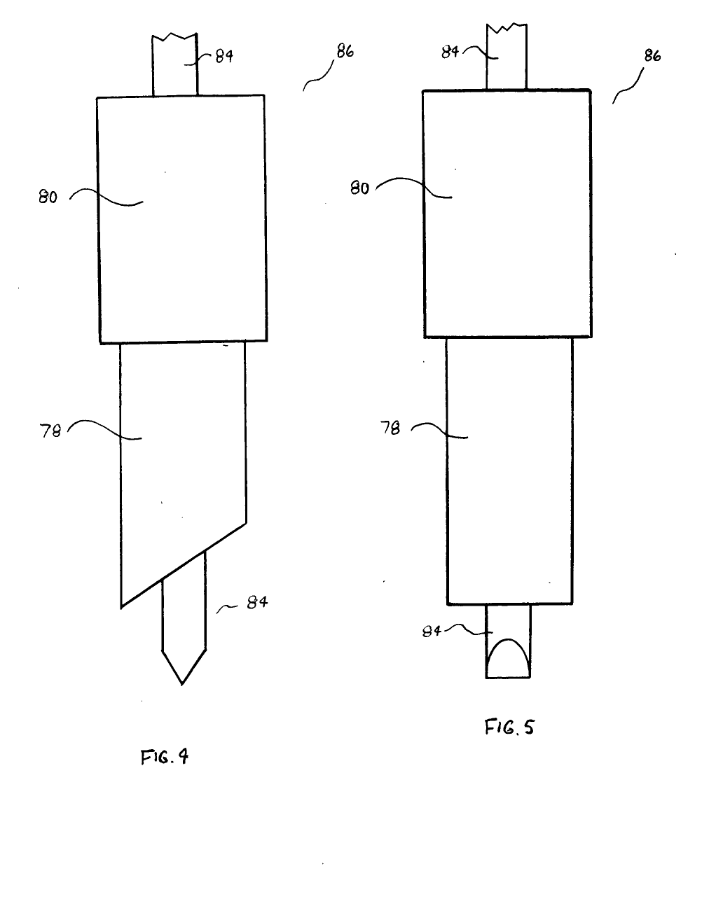

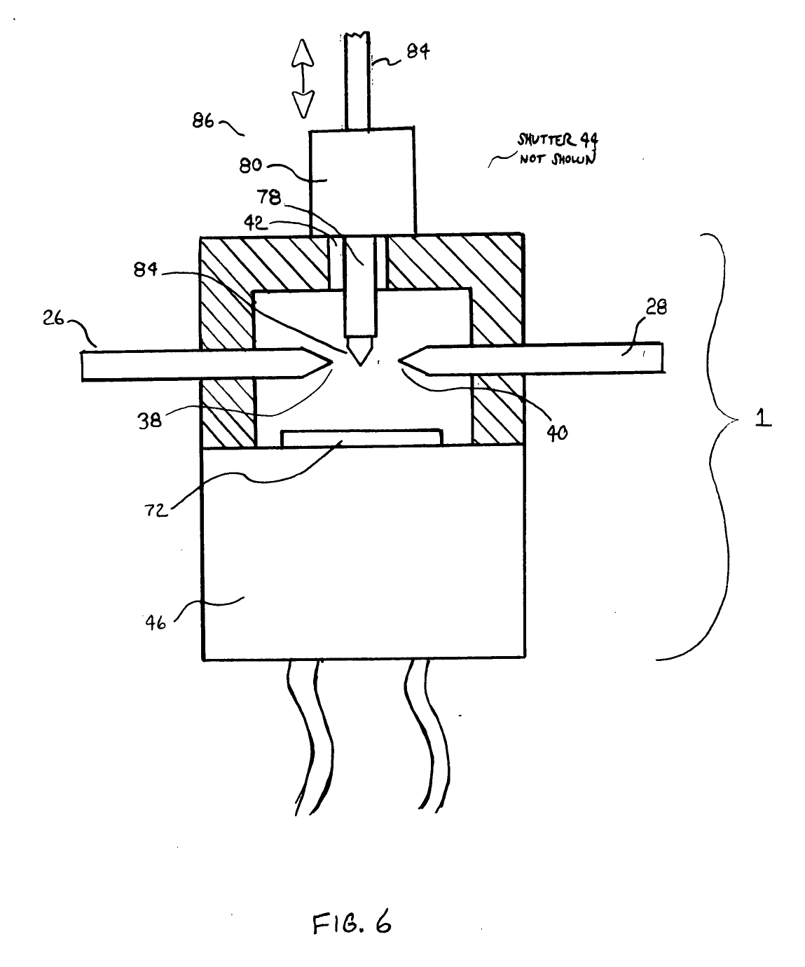

The operation of apparatus 1 will now be described. Referring to FIG. 4 and FIG. 5, a polishing fixture 86 is presented. Polishing fixture 86 is a mechanism for holding an optical fiber 84 during polishing and shaping processes. Suitable polishing fixtures include those used with the FiberSmith™ Bare Fiber Processing System (Model FS200) manufactured by Krell Technologies Inc. (Morganville, N.J.) and referred to as ferrule assemblies. Polishing fixture 86 is comprised of an optical ferrule 78 mounted in a stem fixture 80. Ferrule 78 is press fit into stem fixture 80. The outer diameter of ferrule 78 permits a slip fitting into bushing 42.

An optical fiber 84 has been shaped. Shapes include chiseled, conical, wedge, cleaved and angled. A chiseled shape is illustrated in FIG. 4 and FIG. 5. Optical fiber 84 is located within, and protruding from ferrule 78.

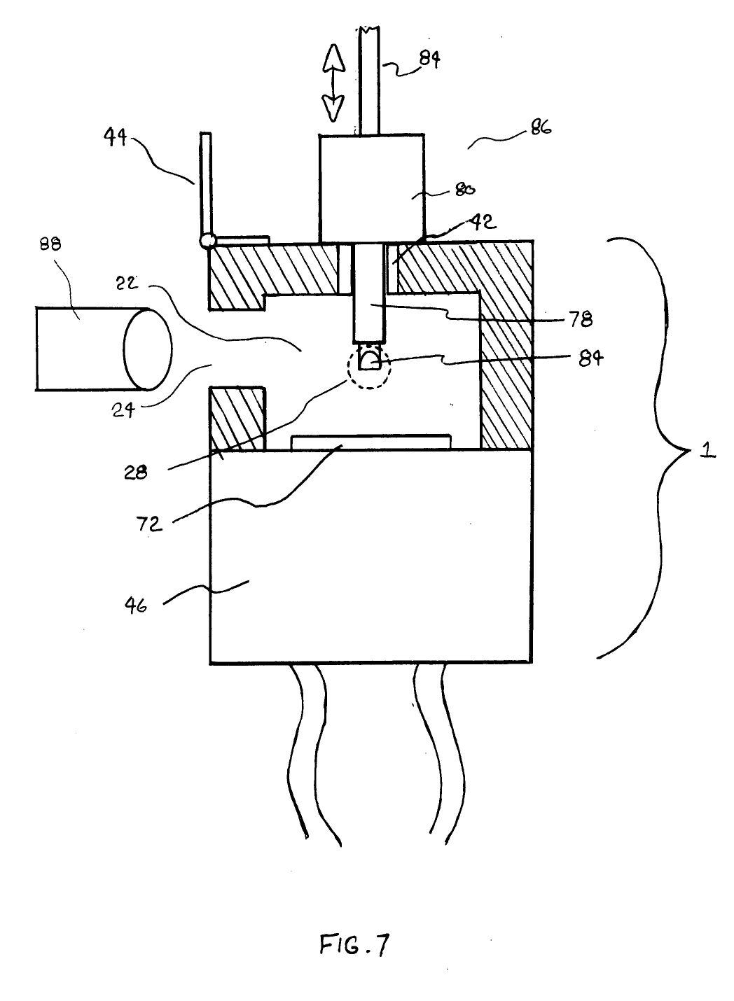

Referring now to FIG. 6 and FIG. 7, apparatus 1 is positioned upon polishing fixture 86 by means of inserting ferrule 78 into bushing 42. Upon contact between bushing 42 and stem fixture 80, the shaped tip of optical fiber 84 is positioned approximately between electrode tips 38 and 40. With shutter 44 in its open position, a microscope 88 is used to monitor the position of optical fiber 84 relative to electrode tips 38 and 40 through viewing window 24. The shaped tip of optical fiber 84 is positioned in line with electrode tips 38 and 40 by moving optical fiber 84 within polishing fixture 86.

After alignment of the shaped tip of optical fiber 84 with electrode tips 38 and 40, shutter 44 is closed over window 24. Shutter 44 optically seals cavity 22 and prevents ambient light from striking CCD active area 72.

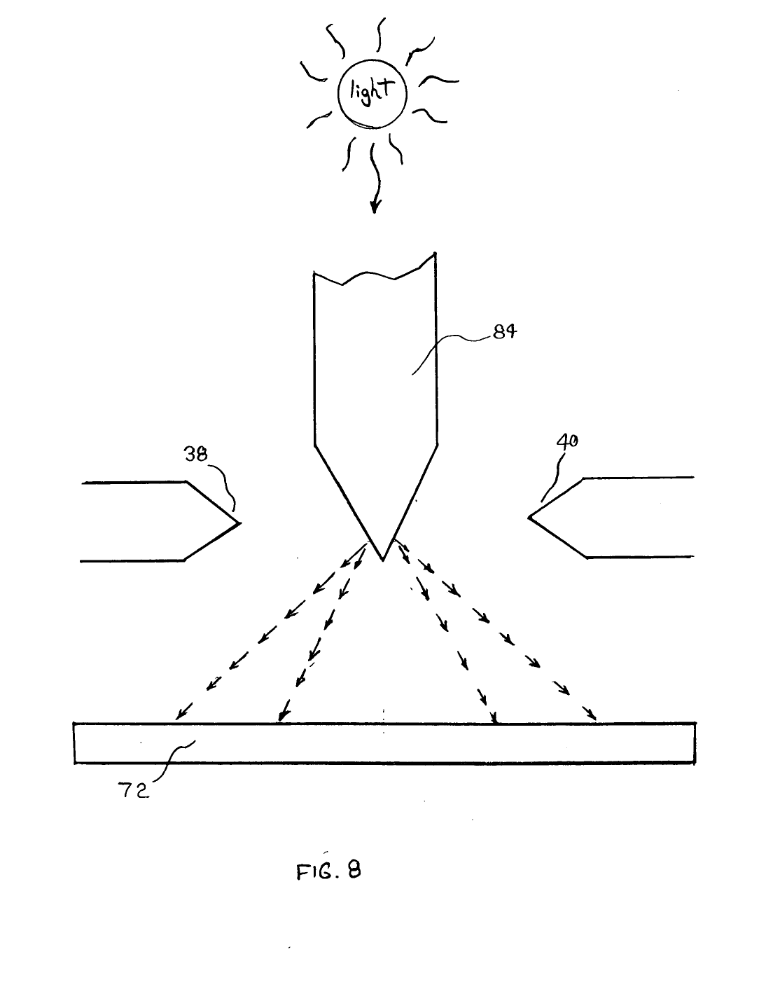

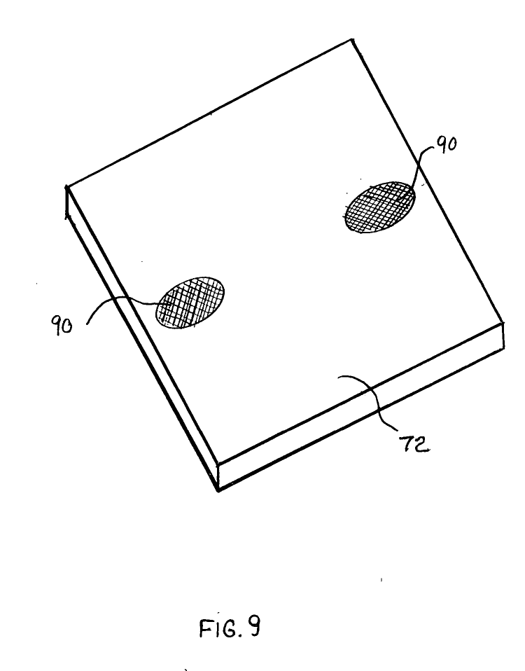

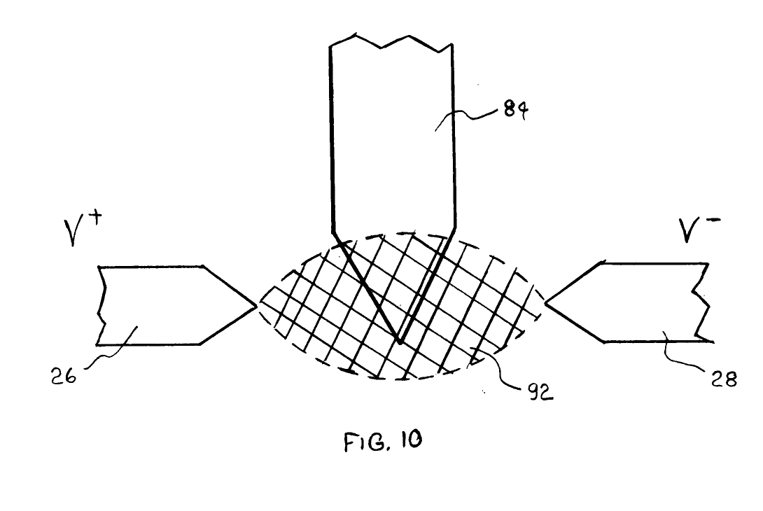

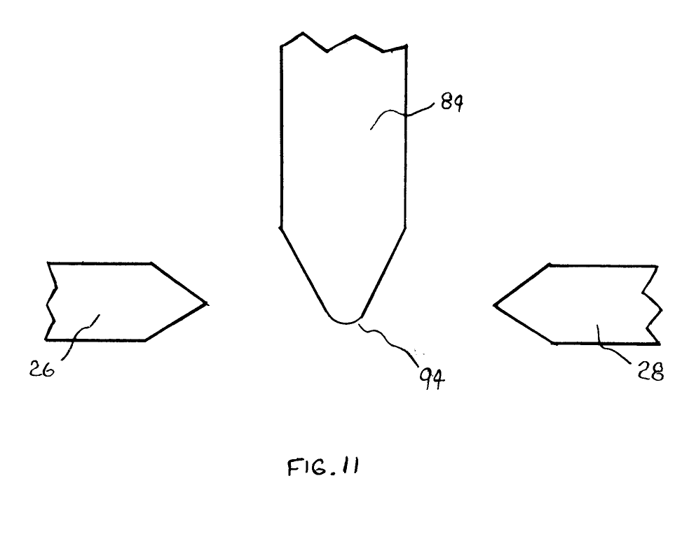

Referring to FIG. 8, light is injected into the far, un-shaped end of optical fiber 84. As the light exits the shaped tip of optical fiber 84, it strikes CCD active area 72 and energizes its surface.

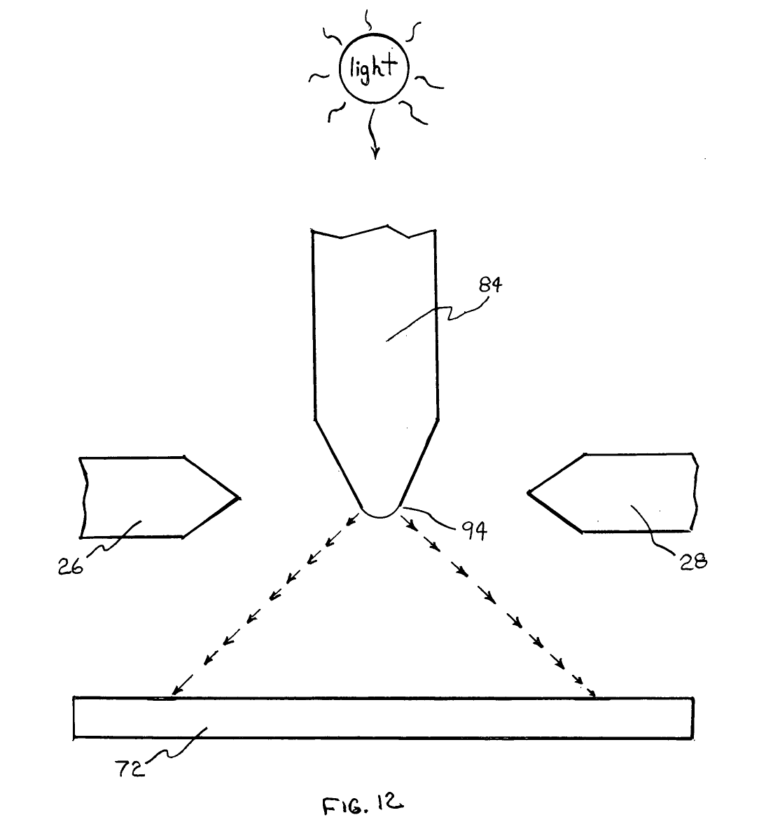

Referring to FIG. 9, the projected light from optical fiber 84 creates a beam pattern 90 upon CCD active area 72. The characteristics of projected beam pattern 90 are determined by the geometry of the shaped fiber tip of optical fiber 84. Beam pattern 90 is converted into a video signal by camera 46 that is transmitted to a video capture board for analysis by commercially available beam profiling software. Suitable beam profiling software include the LBA300PC Laser Beam Analyzer manufactured by Spiricon Inc. (Logan, Utah). Analysis of the beam profile can be use to qualify the geometry of the tip of optical fiber 84 and determine if additional polishing processing is required. If it is determined that optical fiber 84 requires additional polishing and shaping, apparatus 1 can be disengaged from polishing fixture 86.

Referring to FIG. 10, voltage is applied to electrodes 26 and 28 by means of a conventional and commercially available power supply. Once a breakdown voltage is achieved, arcing will occur, creating a plasma field 92 between electrodes 26 and 28. The shaped tip of optical fiber 84 is positioned within plasma field 92.

Referring to FIG. 11, the elevated temperature within plasma field 92 melts the shaped tip of optical fiber 84, creating a radiused tip 94. The resulting radiused tip 94 can be visually viewed with microscope 88 by opening shutter 44.

Referring now to FIG. 12, shutter 44 is once again closed to optically seal cavity 22 and prevent ambient light from striking CCD active area 72. Light is injected into the far, un-shaped end of optical fiber 84. As the light exits radiused tip 94, it focuses upon CCD active area 72 and energizes its surface.

Referring to FIG. 13, the projected light from optical fiber 84 creates a beam pattern 96 upon CCD active area 72. The characteristics of projected beam pattern 96 are determined by the new geometry of radiused tip 94. Beam pattern 96 is converted into a video signal by camera 46 that is transmitted to a video capture board for analysis by commercially available beam profiling software. Analysis of the beam profile can be use to qualify the fiber tip geometry and determine if additional processing is required. If additional radiusing is required, the tip of optical fiber 84 is correctly positioned for the generation of another plasma field 92. If the tip of optical fiber 84 has been over-radiused, apparatus 1 can be disengaged from polishing fixture 86 for additional optical fiber 84 polishing and shaping.

1. An apparatus enabling the shaping of an optical fiber tip, and enabling the beam analysis of transmitted light exiting said fiber tip, while said fiber tip is secured and protruding from a polishing fixture, comprising:
a shaping means;
a profiling means attached to said shaping means;
an interfacing means.

2. The apparatus of claim 1 wherein a electrode pair is positioned along a common longitudinal axis inside a cavity formed within said shaping means. Said electrode pair can be energized to create a plasma field of sufficient heat to alter the shape of said fiber tip.

3. The apparatus of claim 1 wherein said profiling means incorporates a charge coupled device (CCD).

4. The apparatus of claim 1 wherein said interfacing means is disposed upon said shaping means. Said interfacing means is a bushing that engages with said polishing fixture.

5. The apparatus of claim 4 wherein said engagement positions said fiber tip between said electrode pair and above said CCD.

6. The apparatus of claim 1 wherein said shaping means is formed with a window that permits a visual line of sight into said cavity, through which said fiber tip can be aligned with said electrode pair.

7. The apparatus of claim 6 wherein said window provides said line of sight so that said shaping of said fiber tip can be actively monitored.

8. The apparatus of claim 7 wherein a shutter means is disposed upon said window means. Said shutter means can be opened to provide said line of sight.

9. The apparatus of claim 8 wherein, when closed, said shutter means optically seals said cavity of said shaping means.

10. An apparatus that positions an optical fiber tip between a electrode pair and above a photo-sensitive device for the purpose of radiusing said fiber tip, and detecting light transmitted through said fiber tip, comprising:
a radiusing means;
a detection means.

11. The apparatus of claim 10 wherein said radiusing means is disposed upon said detection means.

12. The apparatus of claim 10 wherein said radiusing means is formed with a cavity in which said electrode pair is coaxially aligned above said detection means.

13. The apparatus of claim 10 wherein said radiusing means incorporates an interface that permits the insertion and alignment of said fiber tip between said electrodes and above said detection means.

14. The apparatus of claim 10 wherein said radiusing means is formed with an opening, through which said fiber can be viewed for said alignment between said electrode pair.

15. The apparatus of claim 14 wherein a moveable shutter is disposed upon said opening. Said shutter can be closed blocking ambient light from entering said cavity.

16. The apparatus of claim 10 wherein said detection means incorporates a photo-sensitive device.

17. The apparatus of claim 16 wherein said photo-sensitive device is a charged coupled device (CCD).

18. The apparatus of claim 10 wherein said electrode pair can be energized to create a plasma field.

19. The apparatus of claim 18 wherein the axial gap between said electrode pair can be changed to alter the thermal properties of said plasma field.

20. The apparatus of claim 10 wherein said detection means is positioned near enough to said fiber tip so as to detect the entirety of said transmitted light.
